(19) United States
(12) Patent Application Publication
(10) Pub. No.: US 2015/0342208 A1
(43) Pub. Date: Dec. 3, 2015

(54) HIGH PROTEIN YOGURTS

(71) Applicant: NESTEC S.A., Vevey (CH)

(72) Inventors: Matthew Galen Bunce, Glen Burnie, MD (US); Rajiv Indravadan Dave, Bakersfield, CA (US)

(73) Assignee: NESTEC S.A., Vevey (CH)

(21) Appl. No.: 14/654,633

(22) PCT Filed: Dec. 12, 2013
(86) PCT No.: PCT/EP13/76308

§ 371 Date: Jun. 22, 2015

Related U.S. Application Data
(60) Provisional application No. 61/849,809, filed on Dec. 21, 2012.

(51) Int. Cl. A23C 9/123; A23C 9/13

(52) U.S. Cl. CPC A23C 9/123; A23C 9/1307

(57) ABSTRACT

Yogurts, such as Greek frozen yogurts, and methods of making such yogurts are provided. The yogurts can contain fermented lactose-reduced skim milk such that the protein content of the yogurt is from 5% to 14% by weight of the yogurt, the total solids content is less than 38% by weight of the yogurt, and the amount of lactose is 7% or less by weight of the yogurt. The lactose-reduced skim milk can be the primary protein source in the yogurt, and the yogurt can have no added whey protein, milk protein concentrate (MPC), protein isolates or protein powders. The yogurt can be made without straining. The yogurt has a fat content from 0%-6% by weight of the yogurt, preferably below 5% and most preferably below 3%.

### BACKGROUND

The present disclosure generally relates to food compositions. More specifically, the present disclosure is directed to high protein yogurts containing lactose-reduced skim milk and methods for making such yogurts.

Yogurt is obtained by fermentation of milk, typically with a combination of strains of Streptococcus thermophilus and Lactobacillus bulgaricus but not limited to these cultures, and is present in the form of a gel containing the living strains. Yogurt is a fresh product with complex organoleptic properties, and various processes have been proposed for maintaining or enhancing these organoleptic qualities.

Typical yogurt, including frozen yogurt, has approximately 3-5% protein by weight and 5-7% lactose by weight using conventional skim milk. For frozen yogurt, increasing the amount of lactose above 7% by weight of the yogurt causes the texture to be undesirably gritty and coarse due to lactose crystallization that occurs in the frozen yogurt. Furthermore, traditional skim milk is not capable of providing a high protein content without using added protein or straining the yogurt. For example, added proteins such as whey protein, milk protein concentrate (MPC) and protein isolates can supplement the traditional skim milk in yogurt to achieve a higher protein content. However, this increased amount of total solids in the yogurt can result in a poor textural quality of the yogurt and can limit the growth of the cultures. Moreover, straining yogurt requires additional equipment and creates acidic whey, a by-product of straining, that must be disposed or used in an alternative way.

### SUMMARY

The present disclosure generally relates to yogurts. The yogurts can have an increased amount of protein; can contain lactose-reduced skim milk, condensed skim milk, and optionally cream; and can be fermented at a total solids content of less than 38% by weight. The lactose-reduced skim milk can be the primary protein source in the yogurt.

In an embodiment, a yogurt is provided. The yogurt has a protein content from 5% to 14% by weight of the yogurt.

In an embodiment, the yogurt is a Greek frozen yogurt at least.

In an embodiment, the yogurt has a total solids content less than 38% by weight of the yogurt.

In an embodiment, the yogurt has an amount of lactose that is 7% or less by weight of the yogurt.

In an embodiment, the yogurt further comprises condensed skim milk. The condensed skim milk and the lactose-reduced skim milk are the only protein sources in the yogurt, and the yogurt has an amount of fat less than 0.5% by weight of the yogurt.

In an embodiment, the yogurt further comprises condensed skim milk and cream, wherein the condensed skim milk, the cream and the lactose-reduced skim milk are the only protein sources in the yogurt, and the yogurt has an amount of fat less than 6% by weight of the yogurt.

In an embodiment, the lactose-reduced skim milk is the primary protein source in the yogurt.

In another embodiment, a frozen yogurt is provided. The frozen yogurt comprises a primary protein source that is fermented lactose-reduced skim milk. The yogurt has a protein content from 5% to 14% by weight of the yogurt, a total solids content less than 38% by weight of the yogurt, and an amount of lactose that is 7% or less by weight of the yogurt.

In an embodiment, the frozen yogurt further comprises condensed skim milk. The condensed skim milk and the lactose-reduced skim milk are the only protein sources in the yogurt, and the yogurt has an amount of fat less than 0.5% by weight of the yogurt.

In an embodiment, the frozen yogurt further comprises condensed skim milk and cream, wherein the condensed skim milk, the cream and the lactose-reduced skim milk are the only protein sources in the yogurt, and the yogurt has an amount of fat less than 6% by weight of the yogurt.

In an embodiment, the total solids content of the finished product is from 29% to 33% by weight of the yogurt.

In another embodiment, a method of producing a yogurt is provided. The method comprises the steps of: inoculating a yogurt mix with a culture, the yogurt mix comprising a primary protein source that is lactose-reduced skim milk, the yogurt mix having a protein content from 5% to 14% by weight of the yogurt mix; and fermenting the inoculated yogurt mix, the yogurt being made without straining the yogurt mix at any stage.

In an embodiment, the yogurt mix has a total solids content less than 38% by weight of the yogurt mix, and an amount of lactose that is 7% or less by weight of the yogurt mix.

In another embodiment, a method of producing a Greek yogurt is provided. The method comprises the steps of: inoculating a yogurt mix comprising a primary protein source that is lactose-reduced skim milk, the yogurt mix further comprising condensed skim milk and having an amount of lactose that is 7% or less by weight of the milk and a protein content from 5% to 14% by weight of the milk; and fermenting the inoculated yogurt mix, the yogurt being made without straining the milk at any stage and without adding protein to the milk at any stage.

In an embodiment, the method further comprises at least partially freezing a product containing the fermented inoculated yogurt mix; and at least partially aerating the product.

An advantage of the present disclosure is to provide improved yogurts.

Another advantage of the present disclosure is to provide improved frozen yogurts.

Still another advantage of the present disclosure is to provide improved Greek frozen yogurts.

Yet another advantage of the present disclosure is to provide methods of making yogurts that use standard production equipment without additional equipment such as equipment for adding protein, equipment for straining the yogurt and equipment for disposing by-products of straining.

Another advantage of the present disclosure is to provide yogurts that have higher protein content than typical yogurts.

Still another advantage of the present disclosure is to provide yogurts that have pleasing organoleptic properties such as smooth texture, sweetness and tartness.

Yet another advantage of the present disclosure is to provide yogurts having increased protein content without adding protein to the fermented lactose-reduced skim milk or straining the fermented lactose-reduced skim milk.

Another advantage of the present disclosure is to provide yogurts having increased protein content while maintaining a total solids content of less than 38% of the yogurt by weight.

Still another advantage of the present disclosure is to enable growth of the culture in yogurts by using a lower total solids content from lactose-reduced skim milk relative to typical yogurts.

Yet another advantage of the present disclosure is to provide yogurts having a titratable acid (TA) level from 0.9 to 1.5 while achieving organoleptically acceptable taste without a strong acidic flavor.

Another advantage of the present disclosure is to increase the sweetness of yogurts by replacing some of the lactose content with a sweeter sugar such as sucrose.

Still another advantage of the present disclosure is to provide a yogurt more acceptable to lactose-intolerant consumers.

Additional features and advantages are described herein, and will be apparent from, the following Detailed Description.

### DETAILED DESCRIPTION

All percentages expressed herein are by weight of the total weight of the yogurt composition unless expressed otherwise. All dosage ranges contained within this application are intended to include all numbers, whole or fractions, contained within said range. As used in this disclosure and the appended claims, the singular forms “a,” “an” and “the” include plural referents unless the context clearly dictates otherwise. As used herein, “about” is understood to refer to numbers in a range of numerals. Moreover, all numerical ranges herein should be understood to include all integer, whole or fractions, within the range.

The present disclosure relates to yogurts such as frozen yogurts. For example, the yogurts can be subjected to low-temperature extrusion or low-temperature freezing. As used herein, “frozen yogurt” means yogurt that has been at least partially frozen, and “yogurt” includes both frozen yogurt and yogurt that has not been at least partially frozen. The yogurt can be a Greek style yogurt. Currently there is no standard of identity of “Greek yogurt,” and current acceptable standards are as used herein: “Greek yogurt” means yogurt that does not have protein added to the dairy that is fermented. In other words, the dairy that is fermented is the only protein source in the yogurt. It is noted that “Greek yogurt” sometimes is used by others to mean that the yogurt is strained, but the present disclosure does not use this definition. For example, in a preferred embodiment, the yogurt disclosed herein is not strained, but the yogurt is nevertheless considered “Greek yogurt” because the yogurt does not have additional protein relative to the milk that is fermented, but which uses milk that is already filtered or “strained”. In an embodiment, the yogurt is a Greek frozen yogurt at least, possibly Frozen Greek yogurt. Even if future FDA clarification of the term “Greek yogurt” renders one or more of the disclosed yogurts to be not encompassed by the term, such yogurts will nevertheless have high protein and reduced lactose with no protein added to the dairy that is fermented.

Unexpectedly, the use of lactose-reduced skim milk enables a protein content of 5% to 14% by weight of the yogurt to be achieved while providing a lower total solids content and a lower amount of lactose. For example, in a general embodiment, the yogurt comprises fermented lactose-reduced skim milk such that the protein content of the yogurt is from 5% to 14% by weight of the yogurt, the total solids content is less than 38% by weight of the yogurt, and the amount of lactose is 7% or less by weight of the yogurt. In a preferred embodiment, the yogurt is a frozen yogurt.

As used herein, “lactose-reduced skim milk” is concentrated skim milk through ultra-filtration that has an amount of lactose that is 7% or less by weight of the skim milk. For example, the lactose-reduced skim milk can be produced by removing the lactose in permeates through separation or ultra-filtration. As another example, the skim milk can be treated with lactase. However, the lactose-reduced skim milk is not limited to a specific treatment, and the lactose-reduced skim milk can be any skim milk having an amount of lactose that is 7% or less by weight of the skim milk.

In an embodiment, the total solids content is from 29% to 33%. In a preferred embodiment, the total solids content is about 31%. For example, lactose-reduced skim milk, condensed skim milk, and/or cream can be the only protein sources in the yogurt. The lactose-reduced skim milk is the primary protein source in the yogurt such that the lactose-reduced skim milk provides more protein than any other protein source included in the yogurt. In a preferred embodiment, the yogurt has no added whey protein, milk protein concentrate (MPC), protein isolates or protein powders.

The yogurt has an amount of fat from 0% to 6% by weight of the yogurt, preferably below 5% and most preferably below 3%. The milk fat in the lactose-reduced skim milk and/or the condensed skim milk can be the only fat in the yogurt such that the yogurt can have less than 0.5% fat. Therefore, in an embodiment, lactose-reduced skim milk and condensed skim milk are the only major fat sources in the yogurt, and the yogurt has an amount of fat less than 0.5%. Cream can be added to increase the fat level to 6% before the solids reach an undesirable level. Therefore, in another embodiment, lactose-reduced skim milk, condensed skim milk and cream are the only major fat sources in the yogurt, and the yogurt has an amount of fat less than 6%. Minor fat sources in the yogurt can be mono- and di-glycerides, cocoa butter, oils, or the like.

In an embodiment, the yogurt comprises a stabilizer that is a physical and/or chemical stabilizer and is a hydrocolloid. The hydrocolloid can be pectin, gelatin, carrageenan, agar, acacia gum, sodium alginate, xanthan gum, locust bean gum, carboxymethyl cellulose (CMC) or a combination thereof. The stabilizer can range from 0.001% to 10% by weight, preferably from 0.01% to 5% and most preferably from 0.2% to 0.5% of the yogurt.

The yogurt can also include acidulants including but not limited to lactic acid, malic acid, citric acid, tartaric acid, phosphoric acid, glocono delta lactone and combinations thereof in an amount of 0.01% to 2% by weight, preferably from 0.1-1% by weight of the yogurt. In an embodiment, the titratable acid (TA) level is above 0.9 but the yogurt does not provide a strong acidic flavor. For example, the yogurt can have a TA level from 0.9 to 1.5.

In an embodiment, the yogurt of the present invention includes sugar in an amount up to about 20%, preferably from 10% to 20% by weight, and most preferably from 12% to 15% by weight of the yogurt. The sugar can be lactose from the lactose-reduced skim milk and/or added sugar. In an embodiment, the sugar is lactose from the lactose-reduced skim milk and sucrose added to the lactose-reduced skim milk. For example, the yogurt can have sucrose in an amount of about 7% of the yogurt. The yogurt can also include sugarless sweeteners such as mattitol, mannitol, xylitol, hydrogenated starch hydrolysates, sorbitol, lactitol, erythritol and the like, alone or in combination, although sugarless sweeteners are absent in some embodiments.

High intensity artificial or natural sweeteners can also be used in the yogurt. Preferred high intensity sweeteners include but are not limited to sucralose, aspartame, salts of acesulfame, alitame, saccharin and its salts, cyclamic acid and its salts, glycyrrhizin, stevioside, dihydrochalcones, thaumatin, monellin, and the like, alone or in combination.

In another embodiment, the yogurt comprises a pureed fruit including but not limited to apple, orange, pear, peach, strawberry, banana, cherry, pineapple, kiwi, grape, blueberry, raspberry, mango, guava, cranberry, blackberry or a combination thereof. The fruit may be present in an amount ranging from about 0% to about 30% by weight, preferably from about 3% to about 20% by weight and most preferably from about 5% to about 16% by weight of the yogurt. In an embodiment, the yogurt can include a vegetable ingredient selected from the group including but not limited to sweet potatoes, carrots, peas, green beans and squash.

In an embodiment, the yogurt includes one or more prebiotics. As used herein, a prebiotic is a selectively fermented ingredient that allows specific changes, both in the composition and/or activity in the gastrointestinal microflora, that confers benefits upon host well-being and health. Non-limiting examples of suitable prebiotics include fructooligosaccharides, inulin, lactulose, galactooligosaccharides, acacia gum, soyoligosaccharides, xylooligosaccharides, isomaltooligosaccharides, gentiooligosaccharides, lactosucrose, glucooligosaccharides, pecticoligosaccharides, resistant starches, sugar alcohols, corn fiber or a combination thereof.

In an embodiment, the yogurt includes one or more probiotics. As used herein, probiotics are defined as microorganisms (viable or non-viable) that could confer health benefits on the host when administered in adequate amounts. Non-limiting examples of suitable probiotics include Saccharomyces, Debaromyces, Candida, Pichia, Torulopsis, Aspergillus, Rhizopus, Mucor, Penicillium, Torulopsis, Bifidobacterium, Bacteroides, Clostridium, Fusobacterium, Melissococcus, Propionibacterium, Streptococcus, Enterococcus, Lactococcus, Staphylococcus, Peptostrepococcus, Bacillus, Pediococcus, Micrococcus, Leuconostoc, Weissella, Aerococcus, Oenococcus, Lactobacillus or a combination thereof.

In another embodiment, the yogurt includes one or more amino acids. Non-limiting examples of suitable amino acids include Isoleucine, Alanine, Leucine, Asparagine, Lysine, Aspartate, Methionine, Cysteine, Phenylalanine, Glutamate, Threonine, Glutamine, Tryptophan, Glycine, Valine, Proline, Serine, Tyrosine, Arginine, Histidine or a combination thereof.

As a non-limiting example, the yogurt can be made by inoculating the lactose-reduced skim milk, with or without cream, with a culture comprising Streptococcus thermophilus and Lactobacillus bulgaricus; fermenting the inoculated lactose-reduced skim milk, with or without cream; and then cooling the fermented lactose-reduced skim milk with or without cream. Optionally, the fermented dairy can then be at least partially frozen, such as during extrusion for example, to form frozen yogurt. The yogurt can optionally be aerated before and/or after extrusion. Additional bacteria can be used to ferment the milk, such as Lactobacillus acidophilus and Lactobacillus casei. This process may be performed with condensed skim milk included in one or more steps in addition to the lactose-reduced skim milk.

In a preferred embodiment, the yogurt is made without straining the milk at any stage. The yogurt can be made using standard production equipment without additional equipment such as equipment for adding protein, equipment for straining the yogurt and equipment for disposing by-products of straining.

In a non-limiting example, a yogurt mix of 100% lactose-reduced skim milk contained 3.2 g of lactose per 68 g serving, resulting in a lactose content of 4.6% lactose by weight and a protein level of 6 g/serving pre-fermentation. In contrast, regular skim milk with 5% to 6% added MPC in a typical yogurt mix contains 8.2 g lactose per 71 g serving, resulting in a lactose content of 11.6% by weight and a protein content of 6 g/serving. A yogurt mix of 100% regular skim milk and no added MPC contains 5.44 g lactose per 71 g serving, resulting in a lactose content of 7.66% by weight and a protein content of only 4 g/serving. Therefore, using lactose-reduced skim milk in yogurt as disclosed herein enables an increased protein level without additional lactose and, as a result, prevents gritty texture due to lactose crystallization. In addition, using lactose-reduced skim milk in yogurt provides a lower total solids content in the yogurt mix with higher protein content that supports fermentation by bacteria. This low level of solids and increased protein content, such as 6 g of protein per serving, cannot be achieved by regular skim milk without the addition of WPC, MPC, protein isolates or the like.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A yogurt comprising fermented lactose-reduced skim milk, the yogurt having a protein content from 5% to 14% by weight of the yogurt.

2. A yogurt according to claim 1, wherein the yogurt is a Greek frozen yogurt.

3. A yogurt according to claim 1, wherein the yogurt has a total solids content less than 38% by weight of the yogurt.

4. A yogurt according to claim 1, wherein the yogurt has an amount of lactose that is 7% or less by weight of the yogurt.

5. A yogurt according to claim 1, comprising condensed skim milk, wherein the condensed skim milk and the lactose-reduced skim milk are the only protein sources in the yogurt, and the yogurt has an amount of fat less than 0.5% by weight of the yogurt.

6. A yogurt according to claim 1, comprising condensed skim milk and cream, wherein the condensed skim milk, the cream and the lactose-reduced skim milk are the only protein sources in the yogurt, and the yogurt has an amount of fat less than 6% by weight of the yogurt.

7. A yogurt according to claim 1, wherein the lactose-reduced skim milk is the primary protein source in the yogurt.

8. A frozen yogurt comprising a primary protein source that is fermented lactose-reduced skim milk, the yogurt having a protein content from 5% to 14% by weight of the yogurt, a total solids content less than 38% by weight of the yogurt, and an amount of lactose that is 7% or less by weight of the yogurt.

9. A frozen yogurt according to claim 8 comprising condensed skim milk, wherein the condensed skim milk and the lactose-reduced skim milk are the only protein sources in the yogurt, and the yogurt has an amount of fat less than 0.5% by weight of the yogurt.

10. A frozen yogurt according to claim 8 comprising condensed skim milk and cream, wherein the condensed skim milk, the cream and the lactose-reduced skim milk are the only protein sources in the yogurt, and the yogurt has an amount of fat less than 6% by weight of the yogurt.

11. A frozen yogurt according to claim 9, wherein the total solids content of the frozen yogurt is from 29% to 33% by weight of the yogurt.

12. A method of producing a yogurt, comprising the steps of:
inoculating a yogurt mix with a culture, the yogurt mix comprising a primary protein source that is lactose-reduced skim milk, the yogurt mix having a protein content from 5% to 14% by weight of the yogurt mix; and
fermenting the inoculated yogurt mix, the yogurt being made without straining the yogurt mix at any stage.

13. A method according to claim 12, wherein the yogurt mix has a total solids content less than 38% by weight of the yogurt mix, and an amount of lactose that is 7% or less by weight of the yogurt mix.

14. A method of producing a Greek yogurt, comprising the steps of:
inoculating a yogurt mix comprising a primary protein source that is lactose-reduced skim milk, the yogurt mix further comprising condensed skim milk and having an amount of lactose that is 7% or less by weight of the milk and a protein content from 5% to 14% by weight of the milk; and
fermenting the inoculated yogurt mix, the yogurt being made without straining the milk at any stage and without adding protein to the milk at any stage.

15. A method according to claim 14, further comprising at least partially freezing a product containing the fermented inoculated yogurt mix; and
at least partially aerating the product.
